(19) United States
(12) Patent Application Publication
(10) Pub. No.: US 2014/0190001 A1
(43) Pub. Date: Jul. 10, 2014

(54) RAIL SYSTEM FOR INSTALLING A STATOR CORE IN A FRAME

(71) Applicants: Michael P. Jaszcar, Murrysville, PA (US); Travis John Vitello, Oviedo, FL (US)

(72) Inventors: Michael P. Jaszcar, Murrysville, PA (US); Travis John Vitello, Oviedo, FL (US)

(21) Appl. No.: 13/733,961

(22) Filed: Jan. 4, 2013

(51) Int. Cl. H02K 15/02

(52) U.S. Cl. CPC H02K 15/02
USPC 29/596; 29/732

(57) ABSTRACT

A temporary rail system (12) is provided for installing a stator core (14) in a generator frame (16). The rail system includes rail assemblies (18, 20, 22, 24), where each rail assembly includes support pieces (19, 21, 23) axially positioned at a circumferential location (26, 28, 30, 32) along frame rings (34, 36, 38, 40, 42) of the frame. The rail assembly also includes fasteners (48) to secure the support pieces to the circumferential location. The rail assembly also includes lifting assemblies (52) positioned on each support piece, a support beam segment (62, 64) positioned on each lifting assembly, and a rail segment (66, 68) positioned on each support beam segment such that a rail (69) including the rail segments is axially positioned along the support pieces of the rail assembly.

### FIELD OF THE INVENTION

The present invention relates to the assembly of generator stator cores. More particularly, the invention relates to the horizontal assembly of a stator core using a temporary rail system for the placement of laminations or stator core segments, alternatively referred to as donuts, which form the core.

### BACKGROUND OF THE INVENTION

The generator stator core is the largest monobloc component in the train of a turbine generator set. Stator cores are manufactured from thousands of thin steel laminations which are stacked, pressed and clamped together into the large cylindrical form of the stator core. Clamping is necessary for several reasons but principally to ensure that geometric form is maintained under the forces imposed during unit operation. Improper clamping can result in lamination vibration during generator operation, due to magnetic impulses and/or core elliptical dilation.

Typically, the stator core is assembled at the installation site during a service event (otherwise the cores are assembled in the factory). However, the large size of the stator core results in stator core manufacturing complexities, including the need for generous floor space, high crane requirements, manufacturing lead time and other associated manufacturing difficulties. For example, if the core is stacked directly in the stator frame, the frame must be delivered to the site before any manufacturing steps can occur. Additionally, intermediate core pressing equipment is needed to press and clamp the laminations together at incremental lengths. If, on the other hand, the stator core is manufactured in an external fixture, the external fixture itself adds to the manufacturing costs and requires additional floor space on site and still requires the use of heavy cranes.

U.S. Pat. No. 5,875,540 by Sargeant, which is incorporated herein by reference, overcame some of the problems with the prior art by first assembling a number of laminations into a distinct stator core segment, also referred to as a donut, and then stacking these donuts to form a stator core. This technique saved substantial assembly time compared to assembling the laminations individually, and produced a stator core with fewer flaws.

The prior art requires that the laminations and donuts be stacked vertically, using gravity to guide the donuts into place. This can lead to large scale rearrangement of the stator core and the surrounding area for substantial periods of time. Using the prior art, stacking a core horizontally is extremely difficult with lamination aggregates, and large aggregates, such as donuts, is essentially precluded. What is needed is a method and apparatus for stacking laminations and donuts horizontally. This is particularly needed in pre-existing stator frames, not initially designed for such assemblies, where vertical stacking is not practicable and where room is otherwise limited.

### BRIEF DESCRIPTION OF THE DRAWINGS

The invention is explained in the following description in view of the drawings that show:

FIG. 1 is a perspective cut-away view of a temporary rail system for installing a stator core within a stator frame;

FIG. 2 is a partial view of a rail assembly of the temporary rail system of FIG. 1;

FIG. 3 is a partial view of a rail assembly of the temporary rail system of FIG. 1;

FIG. 4 is a perspective view of a rail template to circumferentially align the rail assembly of FIG. 1;

FIG. 5 is an axial cross-sectional view a stator core segment mounted on the temporary rail system within the stator frame of FIG. 1;

FIG. 6 is an axial cross-sectional view of the temporary rail system of FIG. 5 disengaged from the stator core segment;

FIG. 7 is a tangential cross-sectional view of support pieces of the rail assembly of FIG. 3 disassembled from the stator frame;

FIG. 8 is a perspective view of the support pieces of FIG. 7 being removed from the stator frame;

FIG. 9 is a perspective view of a support beam of the rail assembly of FIG. 7 being removed from the stator frame; and

FIG. 10 is a flow chart depicting a method for installing a stator core in a generator frame.

### DETAILED DESCRIPTION OF THE INVENTION

The inventors have designed a temporary rail system for horizontally installing a stator core within a generator frame. Stator core segments or donuts are horizontally guided along the rail system and into the generator frame. Prior to guiding the stator core segments along the rail system, the rail system is adjusted in the radial and circumferential directions so that the stator core segments guided into the frame will be centered in the frame without requiring any subsequent adjustment to the rail system. After guiding the stator core segments into the generator frame, the stator core is secured to the frame. The rail system is then lowered off the stator core so that the rail system is out of contact with the stator core. The rail system is then disassembled from the generator frame and the rail system is subsequently removed from the generator frame, to be re-used to load a stator core into another generator frame. The temporary rail system is capable of interfacing with the stator core, is capable of supporting the load of the stator core, and can be disassembled for removal from the frame after completion of the stator core assembly.

The rail system includes a plurality of rails that are attached to the generator frame, where the rails are axially aligned along the generator frame at the distinct circumferential locations. Each rail is made of a plurality of axial rail segments, placed end-to-end, axially aligned along the generator frame. Each axial rail segment is supported on a respective support beam segment, which is in-turn secured to the generator frame.

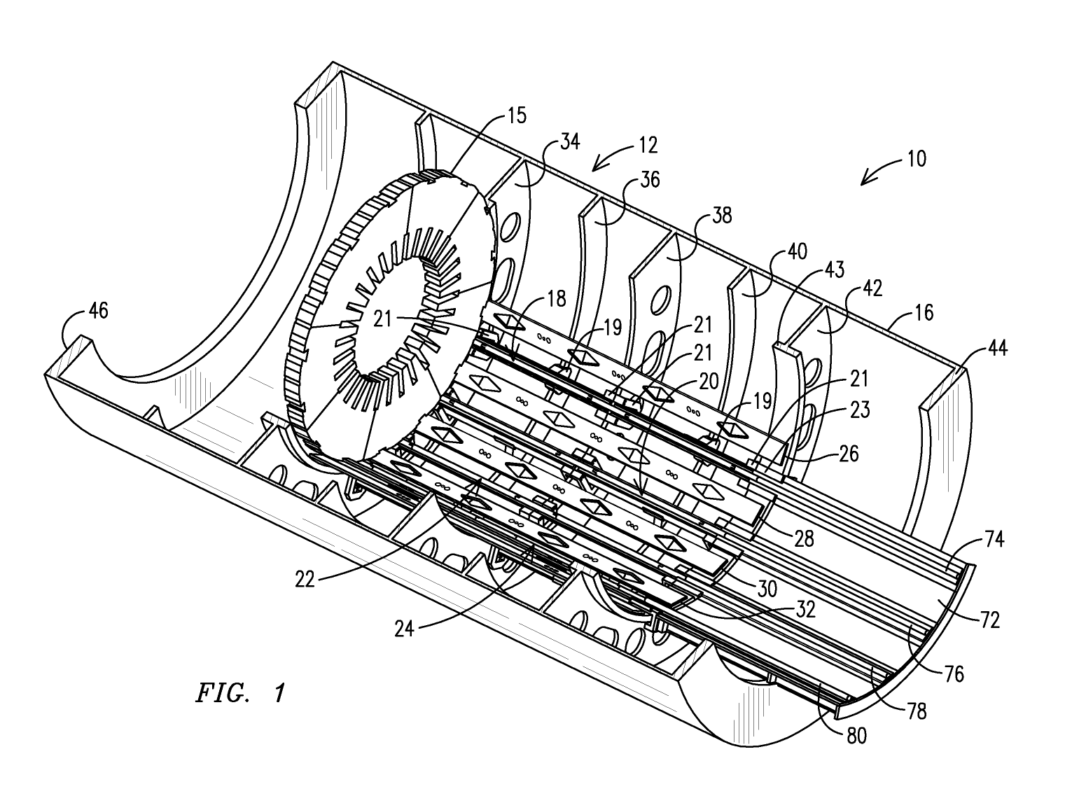

FIG. 1 illustrates a generator 10 with a temporary rail system 12 for installing a stator core in a generator frame 16. In the generator frame 16, a spring assembly (discussed below) is provided to support the stator core, after it is installed. Prior to installing the temporary rail system 12, the generator frame 16 is vacated of any stator core iron and associated components.

As illustrated in FIG. 1, the temporary rail system 12 includes rail assemblies 18, 20, 22, 24 installed in the frame 16, which are axially positioned at a respective circumferential location 26, 28, 30, 32 along frame rings 34, 36, 38, 40, 42 of the frame 16 from an exciter end 44 to a turbine end 46 of the frame 16. FIGS. 1-3 illustrate the structural features of the rail assembly 18, which will be discussed herein and are representative of the structural features of the other rail assemblies 20, 22, 24 of the rail system 12. As illustrated in FIGS. 1-3, the rail assembly 18 includes support pieces 19, 21, 23 that are axially positioned at a circumferential location 26 along frame rings 34, 36, 38, 40, 42 of the frame 16 from the exciter end 44 to the turbine end 46 of the frame 16. In an exemplary embodiment, the support pieces 19, 21, 23 are positioned on the frame rings 34, 36, 38, 40, 42 such that they are axially aligned to receive the rail assembly 18. As illustrated in FIG. 1, the rail system 12 may include four rail assemblies 18, 20, 22, 24 positioned at four respective circumferential locations 26, 28, 30, 32 along the frame rings 34, 36, 38, 40, 42. However, the rail system 12 is not limited to any particular number of rail assemblies, and may include fewer or more than four rail assemblies.

In order to axially align the support pieces 19, 21, 23 of the rail assembly 18, the support pieces are translated circumferentially along the respective frame rings 34, 36, 38, 40, 42 to adjust their relative position, until the support pieces are axially aligned. To verify the axial alignment of the rail assemblies 18, 20, 22, 24, a laser may be employed that is oriented along the axial direction of the frame 16 and the rail assemblies 18, 20, 22, 24 are adjusted until they are aligned with the laser. Alternatively, FIG. 4 discloses an alignment template 25 with rail grooves 33, 35, 37, 39 that are separated by the same distances as the circumferential locations 26, 28, 30, 32 along the frame rings. The rail grooves 33, 35, 37, 39 are sized to receive the rails of the rail assemblies 18, 20, 22, 24. To axially align the support pieces 19, 21, 23, of each rail assembly, the alignment template 25 is positioned on the rail assemblies 18, 20, 22, 24 at incremental locations between the frame ring 34 and the frame ring 42. For example, the alignment template 25 may be positioned on the rail assemblies 18, 20, 22, 24, at each frame ring 34, 36, 38, 40, 42. If one of the rail assemblies is not received within the respective groove 33, 35, 37, 39 of the alignment templates 25, the support pieces 19, 21, 23 of that rail assembly are axially aligned until the rail assembly is received within the respective groove of the alignment templates 25.

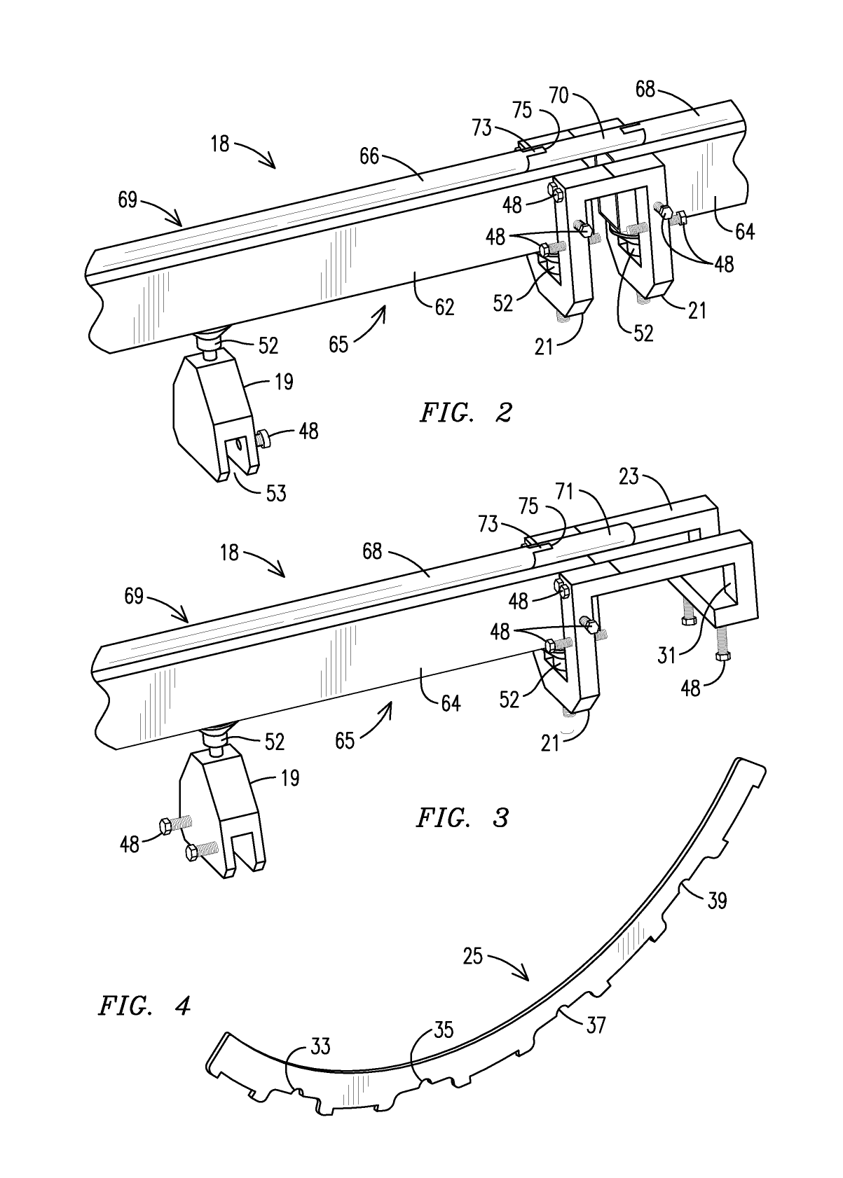

As illustrated in FIGS. 1-3, a pair of support pieces 19 are provided, where each support piece 19 includes a groove 53 that is sized to receive the frame rings 36, 40 and can then be translated circumferentially along the frame rings 36, 40 until the support pieces 19 are positioned at the circumferential location 26 (FIG. 1) of the rail assembly 18. As illustrated in FIGS. 2-3, fasteners 48 are then passed through openings in the support pieces 19, to secure the support pieces 19 to the circumferential location 26 on the frame rings 36, 40. The circumferential locations 26, 28, 30, 32 of the rail assemblies 18, 20, 22, 24 are merely exemplary and may be varied, based on the particular parameters of the generator 10 such as the stator core and the generator frame 16, as appreciated by one of skill in the art.

As illustrated in FIGS. 2-3, the rail assembly 18 includes fasteners 48 that secure the support pieces 19, 21, 23 to the circumferential location 26 along the frame rings 34, 36, 38, 40, 42. As discussed above, one fastener 48 is provided, to secure the support pieces 19 to the circumferential location 26 on the frame rings 36, 40. As illustrated in FIG. 1, a pair of support pieces 21 is secured to opposite sides of the frame ring 38. As illustrated in FIG. 2, a fastener 48 is passed through an axial opening in each support piece 21, and secured into the frame ring 38 between the support pieces 21. Additionally, as illustrated in FIG. 2, a fastener 48 is passed through a tangential opening in each support piece 21, and secured to a support beam segment 62, 64 (discussed below). As further illustrated in FIG. 2, a pair of fasteners 48 are also provided through axial openings in one support piece 21 and secured into the other support piece 21, thereby securing the support pieces 21 together on either side of the support ring 38.

At the last frame ring 42 of the frame 16 adjacent to the exciter end 44, the support pieces 21, 23 are secured to opposite sides of the frame ring 42. As illustrated in FIG. 3, the support piece 23 has a different shape than the support pieces 19, 21. The support piece 23 includes a C-shaped opening 31 that is configured to receive a flange 43 (FIG. 1) of the frame ring 42. When the C-shaped opening 31 is mated with the flange 43 of the frame ring 42, a pair of fasteners 48 is passed through a radial opening in the support piece 23 and into the flange 43 of the frame ring 42, to secure the support piece 23 to the frame ring 42. Additionally, as with the support pieces 21, a pair of fasteners 48 are provided for the support pieces 21, 23, which are passed through axial openings in the support piece 21 and secured into the support piece 23, thereby securing the support pieces 21, 23 on either side of the frame ring 42. Additionally, as with the support pieces 21, a fastener 48 is passed through an axial opening in the support piece 21 and into the frame ring 42, while another fasteners 48 is passed through a tangential opening in the support piece 21 and into the support beam segment 64. The support piece 23 secured to the last frame ring 42 adjacent to the exciter end 44 provides reinforcement at the exciter end 44. Similarly, the corresponding support piece (not shown) secured to the last frame ring 34 provides reinforcement at the turbine end 46. The fasteners 48 used to secure the support piece 23 to the last frame ring 42 may be through studs with mating nuts or some other temporary attachment method. Additionally, the support piece 23 may be capable of being temporarily secured to the frame 16 by tightening temporary positioning members, such as set screws, for example.

As further illustrated in FIGS. 1-3, the rail assembly 18 includes lifting assemblies 52 that are positioned on each support piece 19, 21, with the exception of the support piece 23 attached to the last frame ring 42. In the illustrated embodiment of FIGS. 1-3, the lifting assemblies 52 are threaded lifting assemblies, but any alternative lifting assembly may be employed, such as hydraulic or pneumatic based lifting assemblies, to provide the mechanism necessary to radially adjust the support pieces 19, 21, by providing a force in a radial direction, as discussed in greater detail below.

As further illustrated in FIGS. 2-3, the rail assembly 18 includes a pair of support beam segments 62, 64 which are positioned on the lifting assemblies 52 and are serially arranged along the core axis. More specifically, each support beam segment 62, 64 spans across three lifting assemblies 52 of the support pieces. For example, as illustrated in FIGS. 2-3, the support beam segment 64 is positioned on the lifting assembly 52 of the support piece 21 at the frame ring 38, the lifting assembly 52 of the support piece 19 at the frame ring 40 and the lifting assembly 52 of the support piece 21 at the frame ring 42. However, the rail assembly is not limited to this arrangement and may have less or more than three lifting assemblies for each support beam segment. The support beam segments 62, 64 are secured to the support pieces 19, 21, 23 using the fasteners 48, as discussed above. Collectively, the support beam segments 62, 64 form a support beam 65 that is axially positioned along the support pieces 19, 21, 23 of the rail assembly 18. The support beam segments 62, 64 of FIGS. 2-3 may preferentially have a square or rectangular shaped cross-section, and are capable of supporting the load distribution imposed upon them by the weight of the stator core 14 during its assembly. These support beam segments 62, 64 are sized such that upon their disassembly from the frame 16, they can be removed from the frame 16 intact (i.e. without destructive removal). If necessary, additional supports (not shown) may be provided at axial locations between the support rings 34, 36, 38, 40, 42, and positioned radially between the support beam segments 62, 64 and the inner surface of the frame 16, for reinforcement purposes. In an exemplary embodiment, these additional supports may be screw jacks, wooden blocking, or other appropriate materials, for example. The lifting assemblies 52 are positioned on the support pieces 19, 21, to engage an undersurface of the support beam segments 62, 64, and radially adjust the support pieces 19,21, by providing a force in a radial direction on the support beam segments 62, 64.

As further illustrated in FIGS. 1-3, a pair of rail segments 66, 68 are positioned on the respective support beam segments 62, 64, so that a rail 69 including the rail segments 66, 68 is axially positioned along the support pieces 19, 21, 23 of the rail assembly 18. The rail segments 66, 68 are cylindrical rails with a diameter capable of interfacing with the stator core 14. In an exemplary embodiment, the diameter of the cylindrical rail is 1.75″, for example. However, the rail segments 66, 68 need not comprise cylindrical rails and may instead comprise any other shaped rail that is adaptable to rail grooves in the stator core segments 15. The rail segments 66, 68 may be set on the support beam segments 62, 64 in the stator frame 16 prior to assembly of the stator core, or they may be set on the support beam segments 62, 64 prior to positioning the support beam segments 62, 64 in the stator frame 16. The cylindrical rails of the rail segments 66, 68 may have a flat machined into the base of the cylindrical rail so that the rail segments 66, 68 can sit upon the flat surface of the support beam segment 62, 64. The cylindrical rails of the rail segments 66, 68 may be secured to the support beam segments 62, 64 by welding or by the use of threaded fasteners, for example. Additionally, some other appropriate method may be employed to secure the rail segments 66, 68 to the support beam segments 62, 64 that will allow these components to be positively coupled. As illustrated in FIG. 3, the ends of the rail segments 66, 68 include a tab 73 that interfaces with a slot 75 of an extension piece 70, as discussed below.

As further illustrated in FIGS. 1-3, the extension piece 70 is positioned between consecutive rail segments 66, 68 of the rail assembly 18. The extension piece 70 includes a transition rail which links the gap between consecutive rail segments 66, 68 of the rail assembly 18. The extension piece 70 has the same cross-sectional form and diameter as the rail segments 66, 68. Additionally, the extension piece 70 features the slot 75 to receive the tab 73 of the rail segment 66, to interface the extension piece 70 with the rail 69. The rail assemblies 20, 22, 24 share the same structure and are assembled in the same manner as the rail assembly 18 discussed above.

As illustrated in FIG. 1, an extension cradle 72 is connected to the rail assemblies 18, 20, 22, 24 at the exciter end 44 of the frame 16. However, the extension cradle 72 may be alternatively connected at the turbine end 46. The extension cradle 72 extends from the exciter end 44 of the frame 16 to a turbine deck (not shown). As illustrated in FIG. 1, the extension cradle 72 includes rails 74, 76, 78, 80, and the extension cradle 72 is connected to the rail assemblies 18, 20, 22, 24 so that the rails 74, 76, 78, 80 are aligned with the rails 69 of the rail assemblies 18, 20, 22, 24. As illustrated in FIG. 3, an outer extension piece 71 provides a transition rail between the rail segment 68 of the rail assembly 18 and the rail 74 of the extension cradle 72. As with the extension piece 70 discussed above, the outer extension piece 71 includes a slot 75 to receive the tab 73 of the rail segment 68, to interface the outer extension piece 71 with the rail 69 of the rail assembly 18. A similar outer extension piece 71 is positioned between the rails 76, 78, 80 of the cradle 72 and the rails 69 of the rail assemblies 20, 22, 24.

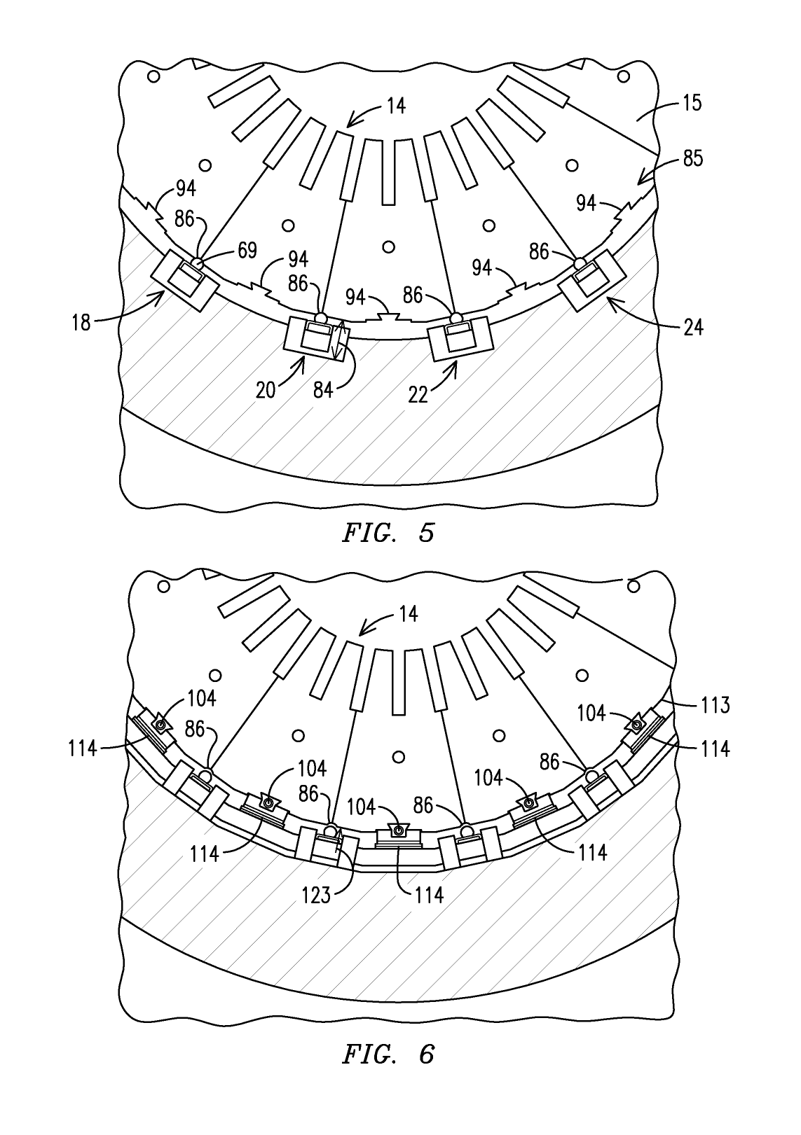

Before the stator core segments 15 are loaded onto the rail system 12 and into the frame 16, the rail assemblies 18, 20, 22, 24 are adjustably calibrated. To verify the axial alignment of the rail assemblies 18, 20, 22, 24, a laser is oriented along the axial direction of the frame 16. In the event that one or more of the support pieces 19, 21, 23 are not axially aligned at the circumferential location of the frame rings 34, 36, 38, 40, 42, the support pieces 19, 21, 23 are circumferentially adjusted along the frame rings 34, 36, 38, 40, 42, until the axial alignment is verified. As illustrated in FIGS. 1 and 5, to calibrate a radial alignment of the rail assemblies 18, 20, 22, 24, the lifting assemblies 52 of each rail assembly is adjusted in the radial direction, so that a radial distance of the rail 69 from a frame 16 center line is adjusted to a first radial distance 84 such that the stator core segments 15 are properly positioned and centered in the frame 16, upon being loaded into the frame 16 along the rails 69. Thus, during the installation of the rail system 12, the rail assemblies 18, 20, 22, 24 are radially adjusted so that the radial distance 84 of the rails 69 interfacing the stator core segments 15 centers the stator core segments 15 in the frame 16 upon installation, without the need to further radial adjustment of the rails 69.

As illustrated in FIG. 5, the stator core segments 15 each include rail grooves 86 along an outer edge 85 of the stator core segment 15. The rail grooves 86 are positioned and sized to be guided along the rails 69 of the rail assemblies 18, 20, 22, 24, to guide the stator core segment 15 into the frame 16. In an exemplary embodiment, the generator 10 may be a Siemens Modular generator, for example. In order to replace the stator core of the generator 10, the stator core segments 15 are bonded together and are individually loaded into the generator frame 16, while the generator frame 16 is maintained in a horizontal orientation. As illustrated in FIG. 1, to load each stator core segment 15 into the generator frame 16, the stator core segment 15 is loaded on a trolley with wheels that travel along the rails 74, 76, 78, 80 of the extension cradle 72 and over the rails 69 of the rail assemblies, until all of the stator core segments 15 are loaded in the frame 16. U.S. Pat. No. 8,220,138 to Majernik discloses a trolley similar to the trolley which would be employed herein and is incorporated by reference herein.

Upon loading all of the stator core segments 15 within the frame 16, the extension cradle 72 is removed from the exciter end 44 of the frame 16, by detaching the extension cradle 72 from the rail assembly 18. The extension cradle 72 is then lifted out of the frame 16, through an opening in the exciter end 44. As illustrated in FIG. 1, the rail assemblies 18, 20, 22, 24 extend between the outer frame ring 34 and the outer frame ring 42, and thus are positioned inside of the exciter end 44 and turbine end 46 of the generator frame 10. Thus, endplates (not shown) may be positioned on the exciter end 44 and turbine end 46 of the stator core 14, without any interference between the endplates and the rail assemblies 18, 20, 22, 24. As discussed in greater detail below, the rail assemblies 18, 20, 22, 24 are removed through openings in the frame rings, and thus do not experience interference with the end-plates.

Upon loading all of the stator core segments 15 into the frame 16, the stator core segments 15 are secured to the frame 16. As illustrated in FIG. 6, the outer edge 85 of the stator core segment 15 includes keybar grooves 94 that are sized to receive keybars 104. Upon securing the keybars within the keybar grooves on the stator core segments 15, the stator core segments 15 are secured to the frame 16, by securing the keybars 104 to spring bars 114 on an inner diameter 113 of the frame 16. Upon securing the stator core 14 to the frame 16, the lifting assemblies 52 for each rail assembly 18, 20, 22, 24 are lowered, or actuated in an outward radial direction from the first radial distance 84 (FIG. 5) to a second radial distance 123 (FIG. 6), so that the rails 69 of the rail assemblies 18, 20, 22, 24 are out of contact with the stator core 14. Thus, the rail system 12 is designed so that the rails 69 of the rail assemblies 18, 20, 22, 24 can have its contact with the stator core 14 removed, after the stator core 14 is fully secured and supported within the frame 16. The rails 69 of the rail assemblies 18, 20, 22, 24 can be lowered from the first radial distance 84 (FIG. 5) to the second radial distance 123 (FIG. 6) while the stator core 14 remains static due to its attachment to the frame 16 via the spring bars 114.

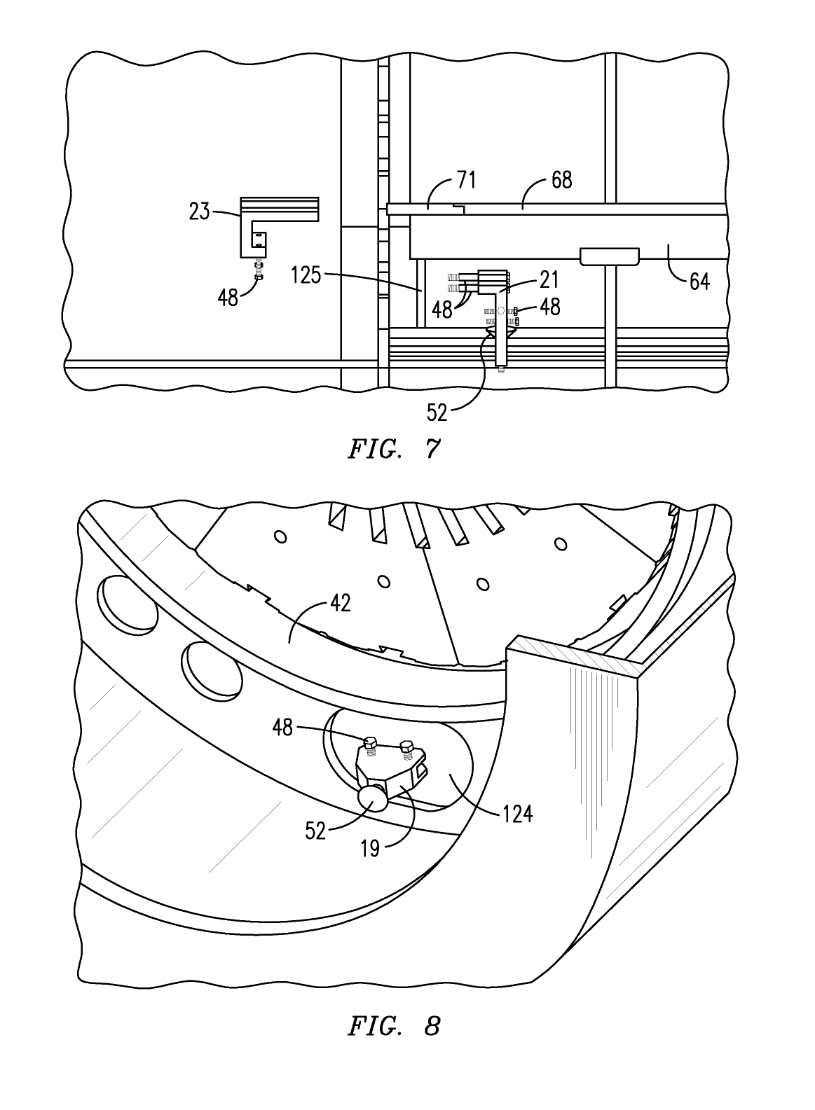

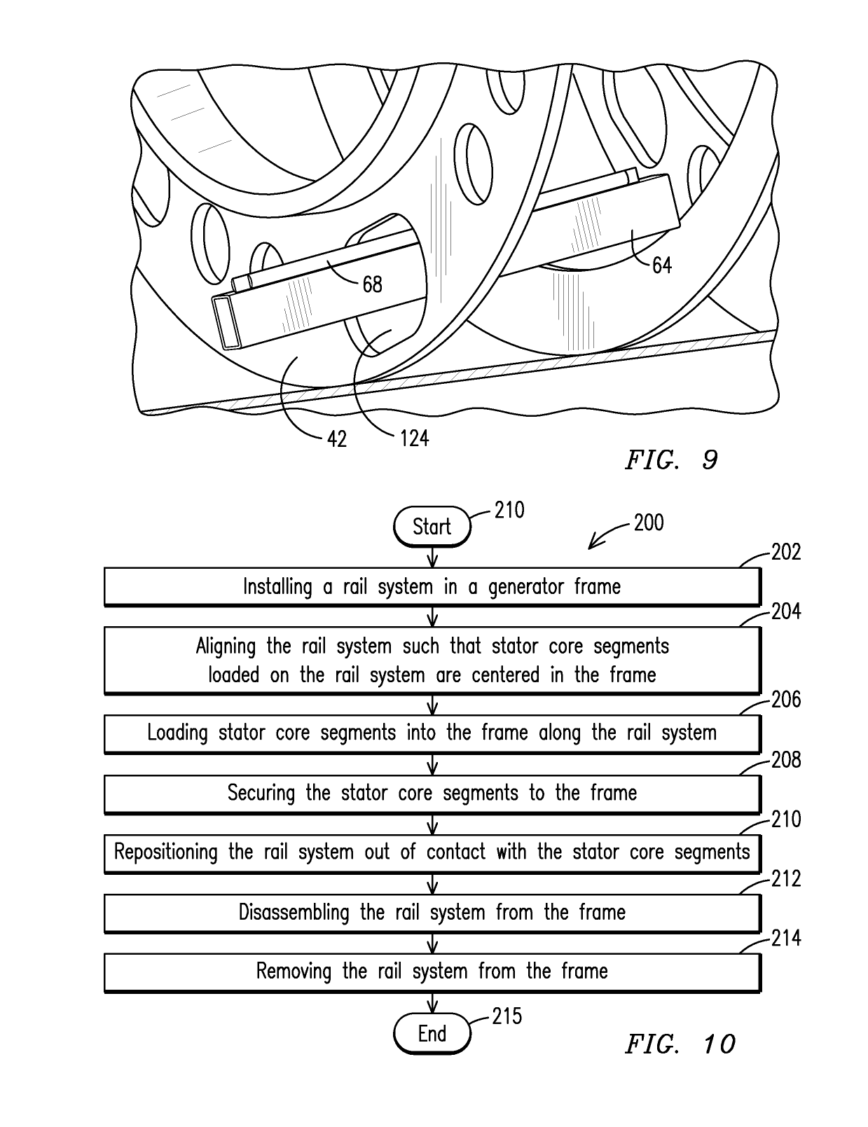

Once all of the stator core segments 15 are delivered into the frame 16, the rail system 12 is disassembled and removed from the frame 16, so that the rail system 12 can be reused to install a stator core in another generator frame. To disassemble and remove the rail system 12 from the frame 16, the rail system 12 is sized such that the individual support beam segments 62, 64 and rail segments 66, 68 are short enough that they can be maneuvered and passed out of the frame 16 by those skilled in the art. As illustrated in FIG. 7, upon lowering the rails 69 of the rail assemblies 18, 20, 22, 24 to be out of contact with the stator core 14, a support member 125 is positioned on an outward radial side of each support beam segment 62, 64 to provide structural support to each support beam segment 62, 64, while the support pieces 19, 21, 23 and lifting assemblies 52 are removed from the frame 16. The fasteners 48 are removed from the openings in the support pieces 19, 21, 23, to unsecure the support pieces 19, 21, 23 and the lifting assemblies 52 from the circumferential locations 26, 28, 30, 32 along the frame rings 34, 36, 38, 40, 42. As further illustrated in FIG. 8, after disassembling the support pieces 19, 21, 23 and lifting assemblies 52, the support pieces and the lifting assemblies are removed from the frame 16 through openings 124 in the outer frame ring 42 of the frame 16. Although FIG. 8 illustrates the opening 124 in the outer frame ring 42, each of the frame rings are provided with openings and thus the support pieces and lifting assemblies may be passed through the openings in each of the frame rings. As illustrated in FIG. 9, after all of the support pieces 19, 21, 23 are removed, the beam segments 62, 64 (and attached rail segments 66, 68) beams are removed from the frame 16, individually by segment. FIG. 9 depicts that the beam segments 62, 64 (and attached rail segments 66, 68) are removed from the frame 16 through the same openings 124 in the outer frame ring 42. The rail segments 66, 68 can be removed with the support beam segments 62, 64 if they are attached, or as separate pieces if they are detached within the frame 16 prior to removal. The frame ring openings 124 are large enough to facilitate passage of the support pieces, lifting assemblies, and the combined support beam segment and rail segment, without interference.

With the frame 16 vacated of the rail system 12 components, an inspection for loose components is performed, to ensure that the stator core 14 is properly supported within the frame 16 by the spring bars 114. The inspection ensures that no element of the rail system 12 or any tooling used to assemble or disassemble the rail system 12 remains within the frame 16 or in any way interfaces with the stator core 14.

FIG. 10 depicts a flowchart of a method 200 for installing the stator core 14 in the generator frame 16. The method 200 starts at 201 by installing 202 the rail system 12 in the frame 16. The method 200 further includes aligning 204 the rail system 12 such that the stator core segment 15 loaded on the rail system 12 is centered in the frame 16. The method 200 further includes loading 206 stator core segments 15 into the frame 16 along the rail system 12. The method 200 further includes securing 208 the stator core segments 15 to the frame 16. The method 200 further includes repositioning 210 the rail system 12 out of contact with the stator core segments 15. The method 200 further includes disassembling 212 the rail system 12 from the frame 16. The method 200 further includes removing 214 the rail system 12 from the frame 16, before ending at 215.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method for installing a stator core in a generator frame, comprising:
installing a rail system in the frame;
aligning the rail system such that a stator core segment loaded on the rail system is aligned to fit within the frame;
loading stator core segments into the frame along the rail system;
securing the stator core segments to the frame;
repositioning the rail system out of contact with the stator core segments;
disassembling the rail system from the frame; and
removing the rail system from the frame.

2. The method of claim 1, wherein the step of aligning of the rail system comprises adjusting a radial distance of the rail system from a frame center line to a first radial distance such that the stator core segments loaded along the rail system are centered in the frame;
and wherein the step of repositioning the rail system comprises repositioning the radial distance of the rail system from the first radial distance to a second radial distance where the rail system is out of contact with the stator core segments at the second radial distance.

3. The method of claim 1, wherein said installing the rail system comprises installing a plurality of rail assemblies in the frame, comprising;
axially positioning a plurality of support pieces at a circumferential location along frame rings of the frame between an exciter end and a turbine end;
securing the plurality of support pieces to the circumferential location along the frame rings;
placing a lifting assembly on each support piece, said lifting assembly configured to radially adjust the support piece;
setting a support beam segment on each lifting assembly such that a support beam including a plurality of support beam segments is axially positioned along the plurality of support pieces of each rail assembly; and
setting a rail segment on each support beam segment such that a rail including a plurality of rail segments is axially positioned along the plurality of support pieces of each rail assembly.

4. The method of claim 3, wherein said installing the plurality of rail assemblies further comprises:
positioning an extension piece between consecutive rail segments of the
respective rail assembly, said extension piece including a transition rail to provide a transition between the consecutive rail segments of the respective rail assembly; and
installing an extension cradle to the rail assemblies at the exciter end or the turbine end of the frame, said extension cradle configured to extend from the exciter end or turbine end of the frame to a proximate turbine deck, said extension cradle including a plurality of rails aligned with the respective rail of each rail assembly of the rail system and including a plurality of outer extension pieces to provide respective transitions between the rails of the extension cradle and the rails of the rail assemblies.

5. The method of claim 3, wherein said aligning of the rail system comprises adjusting a radial distance of the rail system from a frame center line by adjusting the plurality of lifting assemblies of each rail assembly, such that the radial distance of the rail of each rail assembly is adjusted to a first radial height such that the loaded stator core segments into the frame along the rail system are centered in the frame.

6. The method of claim 4, wherein said loading of the stator core segments into the frame along the rail system comprises:
providing a dolly on the rails of the extension cradle;
loading the stator core segment onto the dolly;
moving the dolly and the stator core segments loaded thereon over the rails of the extension cradle and over the rails of the rail assemblies into the frame; and
removing the extension cradle from the frame.

7. The method of claim 1, wherein said securing the stator core segments to the frame comprises:
positioning a plurality of keybars within a respective plurality of keybar grooves along an outer edge of a stator core at a plurality of circumferential positions, said stator core formed by the stator core segments; and
securing the plurality of keybars to a respective plurality of spring bars along an inner diameter of the frame at the plurality of circumferential positions.

8. The method of claim 3, wherein said realigning the rail system out of contact with the stator core segments comprises actuating the plurality of lifting assemblies for each rail assembly of the rail system in an outward radial direction to disengage each rail assembly from the stator core segments.

9. The method of claim 3, wherein said disassembling the rail system comprises:
supporting the rail segments and the support beam segments of each rail assembly; and
detaching the plurality of support pieces and the lifting assemblies of each rail assembly from the circumferential location along the frame rings.

10. The method of claim 9, wherein said removing of the rail system from the frame comprises:
removing the plurality of support pieces and the lifting assemblies of each rail assembly from the frame, after detaching the plurality of support pieces and the lifting assemblies from the frame rings; and
removing the rail segments and support beam segments of each rail assembly from the frame, after removing the plurality of support pieces and the plurality of lifting assemblies of each rail assembly.

11. A rail system for use in installing a stator core in a generator frame, comprising:
a plurality of rail assemblies for installation in the frame, wherein each rail assembly comprises;
a plurality of support pieces positioned at a respective circumferential location along frame rings of the frame from an exciter end to a turbine end of the frame;
a plurality of fasteners configured to secure the plurality of support pieces to the respective circumferential locations along the frame rings;
a plurality of lifting assemblies positioned on the support pieces;
a support beam segment positioned on each lifting assembly such that a support beam including a plurality of support beam segments extends axially along the plurality of support pieces of the rail assembly; and
a rail segment positioned on each support beam segment such that a rail including a plurality of rail segments is axially positioned along the plurality of support pieces of the rail assembly.

12. The temporary rail system of claim 11, further comprising:
an extension piece positioned between consecutive rail segments of each rail assembly, said extension piece including a transition rail to provide a transition between the consecutive rail segments of each rail assembly; and
an extension cradle connected to the rail assemblies at the exciter end of the frame, said extension cradle configured to extend from the exciter end of the frame to a turbine deck, said extension cradle including a plurality of rails aligned with the respective rail of each rail assembly of the rail system and including a plurality of outer extension pieces to provide transition rails between the rails of the extension cradle and the respective rails of the rail assemblies.

13. The temporary rail system of claim 11, wherein during a calibration stage, the lifting assemblies of each rail assembly are adjusted, to adjust a radial distance of the rails of each rail assembly to a first radial distance, so that upon loading stator core segments into the frame along the rails, the stator core segments are centered in the frame.

14. The temporary rail system of claim 11, wherein the stator core comprises a plurality of stator core segments, wherein each stator core segment comprises:
a plurality of rail grooves along an outer edge of the stator core segment that are configured to be guided along the plurality of rails of the plurality of rail assemblies to guide the stator core segment into the frame;
a plurality of keybar grooves along the outer edge of the stator core segment that are configured to receive a plurality of keybars; and
wherein the plurality of keybars are secured to a plurality of spring bars on an inner diameter of the frame to secure the stator core to the frame.

15. The temporary rail system of claim 13, wherein upon securing the stator core to the frame, the plurality of lifting assemblies for each rail assembly are configured to be actuated in an outward radial direction from the first radial distance to a second radial distance so that the rail of the rail assembly is out of contact with the stator core.

16. The temporary rail system of claim 15, wherein upon the rail of the rail assembly being out of contact with the stator core segments:
a support member is positioned on an outward radial side of each support beam segment to provide structural support to each support beam segment; and
the plurality of fasteners are removed to unsecure the plurality of support pieces and the plurality of lifting assemblies from the circumferential location along the frame rings.

17. The temporary rail system of claim 16, wherein the frame rings define a plurality of openings to remove the plurality of support pieces and the plurality of lifting assemblies from the frame.

18. A system for installing a stator core in a frame comprising:
a rail system installed in the frame;
a lifting assembly configured to adjust a height of the rail system such that stator core segments guided into the frame along the rail system are aligned to fit in the frame; and
a plurality of keybars for securing the stator core segments to the frame;
wherein the rail system is configured to be detached and removed from the frame once the stator core segments are secured to the frame.

19. The system of claim 18, wherein upon the stator core segments being secured to the frame, the lifting assembly is configured to lower the height of the rail system such that the rail system is moved out of contact with the stator core segments;
and wherein upon the rail system being moved out of contact with the stator core segments, the rail system is configured to be detached and removed from the frame through an opening in the frame.

20. The system of claim 18, wherein the rail system comprises:
a plurality of rail assemblies in the frame, wherein each rail assembly comprises:
a plurality of support pieces axially positioned at a circumferential location along frame rings of the frame from an exciter end to a turbine end of the frame;
a plurality of fasteners configured to secure the plurality of support pieces to the circumferential location along the frame rings;
a plurality of lifting assemblies positioned on each support piece, said lifting assembly configured to radially adjust each support piece;
a support beam segment positioned on each lifting assembly such that a support beam including a plurality of support beam segments is axially positioned along the plurality of support pieces of the rail assembly, and
a rail segment positioned on each support beam segment such that a rail including a plurality of rail segments is axially positioned along the plurality of support pieces of the rail assembly.
